(19) United States
(12) Patent Application Publication
(10) Pub. No.: US 2013/0108845 A1
(43) Pub. Date: May 2, 2013

(54) OLEOPHOBIC MEMBRANE STRUCTURES INCLUDING A POROUS POLYMERIC COATING

(71) Applicant: YitHong Tee, Lee's Summit, MO (US)

(72) Inventor: YitHong Tee, Lee's Summit, MO (US)

(21) Appl. No.: 13/285,906

(22) Filed: Oct. 31, 2011

(51) Int. Cl. B32B 5/30; B05D 1/36

(52) U.S. Cl. 428/206; 427/202

(57) ABSTRACT

A membrane structure is provided. The membrane structure includes an air permeable hydrophobic membrane having a first side and an opposite second side. An oleophobic conformal coating is applied across the membrane. Moreover, a porous polymeric coating is applied onto the first side and/or the second side of the membrane. A patterned layer of particles are applied onto the porous polymeric coating.

### BACKGROUND OF THE INVENTION

The field of the invention relates generally to composite membrane structures and, more particularly, to composite porous membranes having oleophobic properties and a porous polymeric coating applied thereon.

It is known that a porous membrane may have at least one property that is limited by the material that the membrane is made from. For example, a porous membrane fabricated from an expanded polytetrafluoroethylene (ePTFE) material that is intended for use in articles, such as but not limited to garments, apparel, tent walls, sleeping bags, and packaging, having excellent hydrophobicity. As such, the ePTFE membrane is considered to be waterproof at a relatively low challenge pressure. However, because of its porosity, the same ePTFE membrane tends to absorb oil. The absorption of oil could affect the hydrophobicity in areas of the membrane that have absorbed the oil to a degree that portions of the membrane may no longer be considered waterproof.

One known way to protect an ePTFE membrane from contamination by oil is by coupling a continuous hydrophilic film to the ePTFE membrane to protect one side of the ePTFE membrane from oil. However, this structure is not air permeable and the hydrophilic film must contain moisture to enable the moisture to be channeled through the membrane. The moisture present in the hydrophilic film causes the garment to become heavier. A person wearing a garment incorporating the membrane with the hydrophilic film may feel uncomfortable if the hydrophilic film is exposed to and traps moisture against the wearer's body, especially in cool environments. Such discomfort has been described by wearers as being a “wet and clammy” feeling. Such discomfort may be further aggravated by a lack of air or vapor moving through the garment that could serve to carry the moisture away from inside the garment.

### BRIEF DESCRIPTION OF THE INVENTION

In one embodiment, a membrane structure is provided. The membrane structure includes an air permeable hydrophobic membrane having a first side and an opposite second side. An oleophobic conformal coating is applied across the membrane. Moreover, a porous polymeric coating is applied onto the first side and/or the second side of the membrane. A patterned layer of particles are applied onto the porous polymeric coating.

In another embodiment, an article is provided. The article includes a first layer and a second layer. The first layer includes a fabric and the second layer includes an air permeable hydrophobic membrane that has a first side and an opposite second side. An oleophobic conformal coating is applied across the membrane. A porous polymeric coating is applied onto the first side and/or the second side of the membrane. A patterned layer of particles are applied onto the porous polymeric coating.

In yet another embodiment, a method of making a membrane structure is provided. An air permeable hydrophobic membrane having a first side and an opposite second side is provided. The membrane is coated with an oleophobic conformal coating to impart oleophobic properties to the membrane. The first side and/or the second side of the membrane are coated with a porous polymeric coating. A patterned layer of particles are applied onto the porous polymeric coating.

### BRIEF DESCRIPTION OF THE DRAWINGS

FIG. 1 is an enlarged schematic illustration of a portion of an exemplary membrane structure;

FIG. 2 is an enlarged sectional view of a portion of the membrane structure shown in FIG. 1 and taken along area 2;

FIG. 3 is an enlarged view of an exemplary discontinuous patterned layer applied to the membrane structure shown in FIG. 2;

FIG. 4 is an exploded cross-sectional view of the membrane structure shown in FIG. 2 and taken along area 4;

FIG. 5 is an enlarged end view of the membrane structure shown in FIG. 4; and

FIG. 6 is a flow chart of an exemplary method of making the membrane structure shown in FIG. 4.

### DETAILED DESCRIPTION OF THE INVENTION

The embodiments described herein provide a membrane structure that may be used with articles, such as but not limited to garments, apparel, tent walls, sleeping bags, and packaging, wherein the membrane structure is protected from oil contamination and, at the same time, is air permeable and waterproof. More specifically, the embodiments described herein include a membrane structure that includes an air permeable hydrophobic membrane having a first side and an opposite second side. An oleophobic conformal coating is applied across the membrane. A porous polymeric coating is applied onto the first side and/or the second side of the membrane. A patterned layer of particles are applied onto the porous polymeric coating. Accordingly, the membrane structure is treated to have various desired functionalities, such as being air permeable, waterproof, breathable, and oleophobic. Such treatment also enables the membrane structure to have enhanced mechanical stability, abrasion durability, surface chemicals adsorptivity, antistatic properties, antimicrobial properties, bio-compatibility, and fouling resistance.

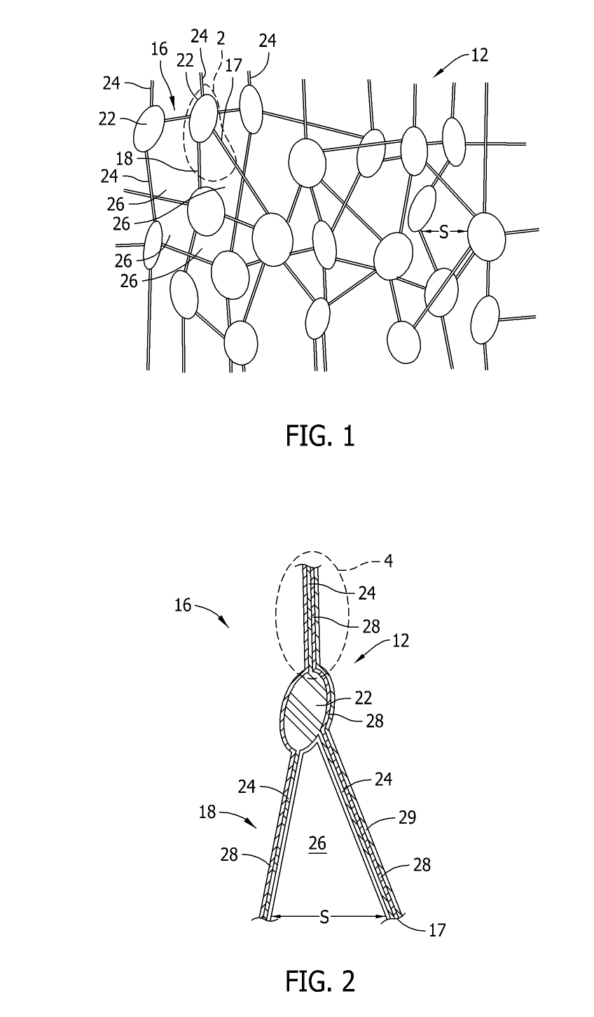

FIG. 1 is a schematic illustration of an exemplary embodiment of a composite membrane structure 12 that can be used in articles, such as but not limited to garments, apparel, tent walls, sleeping bags, and packaging. Composite membrane structure 12 facilitates moisture vapor transmission, and is wind resistant, waterproof, and air permeable. Composite membrane structure 12 also has enhanced mechanical stability, abrasion durability, surface chemicals adsorptivity, antistatic properties, antimicrobial properties, bio-compatibility, and fouling resistance. For example, composite membrane structure 12 is hydrophobic, oleophobic, and offers protection from contaminating agents, such as oil-containing body fluids in the form of perspiration.

In the exemplary embodiment, the term “moisture vapor transmission” is used to describe the passage of water vapor through a structure, such as composite membrane structure 12. The term “waterproof” is used to describe that composite membrane structure 12 does not “wet” or “wet out” by a challenge liquid, such as water, and prevents the penetration of a challenge liquid through composite membrane structure 12. The term “wind resistant” is used to describe the ability of composite membrane structure 12 to substantially prevent air penetration above more than about three cubic feet per minute (CFM) per square foot at a differential pressure drop of about 0.5 inches of water, but that structure 12 has some air permeability that facilitates enhancing a comfort level to someone wearing the laminated fabric. The term “air permeable” is used to describe the ability of composite membrane structure 12 to permit a relatively small amount, for example, less than about three CFM per square foot, of air to pass through it. The term “oleophobic” is used to describe a material that is resistant to contamination from absorbing oils, greases, soap, detergent or body fluids, such as perspiration.

Composite membrane structure 12 includes an untreated or unmodified hydrophobic membrane 16 that has a first side 17 and an opposite second side 18. Membrane 16 is porous, and is preferably microporous, with a three-dimensional matrix or lattice type structure of a plurality of nodes 22 interconnected by a plurality of fibrils 24. Membrane 16 is fabricated from any suitable material, such as, but not limited to expanded polytetrafluoroethylene (ePTFE) or a PTFE fabric. In one embodiment, the ePTFE has been at least partially sintered. Generally, the size of a fibril 24 that has been at least partially sintered is in the range of about 0.05 micron to about 0.5 micron in diameter taken in a direction normal to the longitudinal extent of fibril 24.

Surfaces of nodes 22 and fibrils 24 define numerous interconnecting pores 26 that extend in a tortuous path completely through membrane 16 between opposite sides 17 and 18 of membrane 16. In one embodiment, the average size S of pores 26 in membrane 16 is sufficient to be deemed microporous, but any pore size can be used. In one exemplary embodiment, a suitable average size S for pores 26 in membrane 16 is about 0.01 microns to about 10 microns. In another embodiment, the suitable average size S of pores 26 is between about 0.1 microns to about 5.0 microns.

Membrane 16, in one embodiment, is fabricated by extruding a mixture of polytetrafluoroethylene (PTFE) fine powder particles (available from DuPont under the name TEFLON® fine powder resin) and lubricant. The extrudate is then calendared. The calendared extrudate is then “expanded” or stretched in at least one, and preferably, in at least two directions to form fibrils 24 connecting nodes 22 in a three-dimensional matrix or lattice type of structure. The term “expanded” is intended to mean sufficiently stretched beyond the elastic limit of the material to introduce permanent set or elongation to fibrils 24. In one embodiment, membrane 16 is heated or “sintered” to reduce and minimize residual stress in the ePTFE material. However, in alternate embodiments, membrane 16 is unsintered or partially sintered as is appropriate for the contemplated use of membrane 16.

Other materials and fabrication methods can be used to form a suitable membrane 16 that has an open pore structure. For example, other suitable materials include, but are not limited to, polyolefin, polyamide, polyester, polysulfone, polyether, acrylic and methacrylic polymers, polystyrene, polyurethane, polypropylene, polyethylene, cellulosic polymer and combinations thereof. Other suitable fabrication methods of making a porous membrane include foaming, skiving or casting any of the suitable materials.

It is known that ePTFE, while having excellent hydrophobic properties, is not oleophilic. That is, the ePTFE used in making membrane 16 is susceptible to contamination by absorbing oil. If oil is absorbed, the oil-contaminated regions of membrane 16 are considered “fouled” because the pores 26 can be easily wet by a challenge liquid, such as water, and membrane 16 is no longer considered waterproof. Liquid penetration resistance of membrane 16 that has been fouled may be lost if a challenge fluid or liquid can “wet” the membrane. Membrane 16 is normally hydrophobic, but loses its liquid penetration resistance when a challenge liquid initially contacts and wets a major side of membrane 16 and, subsequently, contacts and wets the surfaces defining pores 26 in membrane 16. Progressive wetting of the surfaces defining interconnecting pores 26 occurs until the opposite major side of membrane 16 is reached by the wetting or challenge liquid. If the challenge liquid cannot wet the membrane 16, liquid penetration resistance is retained.

FIG. 2 is an enlarged schematic sectional view of a portion of composite membrane structure 12 taken along area 2 (shown in FIG. 1). In the exemplary embodiment, a first coating layer 28 and a second coating layer 29 are each formed on membrane 16. First coating layer 28 is an oleophobic conformal coating that may enhance oleophobic and hydrophobic properties of membrane 16 without compromising air permeability of membrane 16. For example, coating layer 28 may reduce the surface energy of membrane 16 to facilitate reducing the capability of oils and oily contaminants from wetting membrane 16 and entering pores 26. Coating layer 28 may also increase the contact angle for oils and/or oily contaminants relative to membrane 16. Coating layer 28 includes coalesced oleophobic fluoropolymer solids.

Although coating layer 28 may include other fluoropolymer materials, in some embodiments coating layer 28 is formed from a coating composition that includes a fluoropolymer that has an acrylic-based polymer with fluorocarbon side chains. The side chains have been found to have a relatively low surface tension, so it is desirable to extend these away from membrane 16. For example, the oleophobic fluoropolymer used in coating layer 28 is, in some embodiments, in the form of a stabilized water-miscible dispersion of perfluoro alkyl acrylic copolymer and/or perfluoro alkyl methacrylic copolymer solids, such as, but not limited to, water-based dispersions of Zonyl® 8195, 7040, 8412, and/or 8300, available from E.I. DuPont de Nemours and Company, Wilmington, Del. Other suitable fluoropolymers include, but are not limited to, a fluorinated acrylate, a fluorinated methacrylate, a fluorinated n-alkyl acrylate and a fluorinated n-alkyl methacrylate. In some embodiments, the oleophobic fluoropolymer may also contain relatively small amounts of acetone and ethylene glycol or other water-miscible solvents and surfactants that were used in the polymerization reaction.

The coating composition forming coating layer 28 includes, in one embodiment, an amount of the oleophobic fluoropolymer in the range of about 0.1 wt % to about 10 wt % based on a total weight of the coating composition. In another embodiment, the coating composition includes an oleophobic fluoropolymer in the range of about 0.5 wt % to about 1.5 wt %. Although the coating composition may include other amounts of solvent, other than water, in some embodiments, the coating composition that forms coating layer 28 includes an amount of solvent, other than water, in the range of about 40 wt % to about 80 wt %. For example, in some embodiments the coating composition includes an amount of solvent, other than water, in the range of about 50 wt % to about 75 wt %. Although the coating composition may include other amounts of stabilizing agent, in some embodiments the coating composition forming coating layer 28 includes an amount of stabilizing agent in the range of about 5 wt % to 50 wt %. For example, in some embodiments the coating composition includes an amount of stabilizing agent in the range of about 15 wt % to about 25 wt %.

The coating composition forming coating layer 28 has a surface tension and a relative contact angle that enable the coating composition to wet pores 26 in membrane 16 such that pores 26 are coated with the oleophobic fluoropolymer solids in the coating composition. However, in some embodiments membrane 16 is wet with a solution containing a solvent before the coating composition is applied to membrane 16. In such embodiments, the coating composition will pass through membrane pores 26 and “wet-out” surfaces of membrane 16. In some embodiments, a stabilizing agent and/or solvent is used to dilute a dispersion of oleophobic fluoropolymer solids to a predetermined solids content. It may be desirable to increase a ratio of the stabilizing agent to solvent to increase the stability of the coating composition. However, enough solvent must be present to ensure wetting of membrane 16 and flow of the coating composition into membrane pores 26.

The coating composition is applied to membrane 16 such that substantially all of the surfaces of the nodes 22 and fibrils 24 are at least partially wetted and such that membrane pores 26 are not blocked. The coating composition adheres and conforms to the surfaces of nodes 22 and fibrils 24 that define membrane pores 26. It is not necessary that the coating composition completely encapsulate the entire surface of a node 22 or fibril 24 or be continuous to increase oleophobicity of membrane 16. The coating composition is then cured by heating membrane 16 such that the oleophobic fluoropolymer flows and coalesce, and such that the stabilizing agents and solvents are removed. During the application of heat, the thermal mobility of the oleophobic fluoropolymer allows the fluoropolymer to be mobile and flow around, engage, and adhere to the surfaces of, nodes 22 and fibrils 24, and therefore coalesce to form coating layer 28. At the relatively elevated temperature, the mobility of the oleophobic fluoropolymer also permits the fluorocarbon side chains to orient themselves to extend in a direction away from the surface of nodes 22 and fibrils 24.

Coating 28 adheres and conforms to the surfaces of nodes 22 and fibrils 24 that define pores 26 in membrane 16. Coating 28 facilitates improving or modifying the oleophobicity of the material of membrane 16 to resist contamination from absorbing contaminating materials such as oils, body oils in perspiration, fatty substances, soap, detergent-like surfactants and other contaminating agents. Also, composite membrane structure 12 remains durably liquid penetration resistant when subjected to rubbing, touching, folding, flexing, abrasive contact or laundering.

In the exemplary embodiment, second coating 29 is a porous polymeric coating that is applied onto first side 17 of membrane 16 after membrane 16 has been treated with coating 28. Alternatively, second coating 29 may be applied onto second side 18 and/or first side 17. Coating 29 may be a porous polyurethane, such as a polyurethane that is capable of adhering onto sides 17 and/or 18. For example, inclusion of polar groups in coating 29 facilitates adhesion of coating 29 onto sides 17 and/or 18. Some types of suitable polar groups for this purpose may include carboxylic acid, amine, ester, amide, hydroxyl, urethane, urea, and/or urea groups. Alternatively, a non-polar (e.g., hydrocarbon or fluorohydrocarbon) polymeric coating may also be used.

Coating 29 may also include a vinyl polymer. Exemplary types of vinyl monomer units from which the vinyl polymer can be synthesized include but are not limited to styrene (e.g., polystyrene or a copolymer of styrene), vinylacetate (e.g., poly(vinylacetate) or a copolymer of vinylacetate), ethylene (e.g., polyethylene or a copolymer of ethylene), propylene (e.g., polypropylene or a copolymer of propylene), vinyl toluene (e.g., polyvinyl toluene or a copolymer of vinyltoluene), chloro-containing vinyl monomers, such as vinylchloride (e.g., poly(vinyl chloride) or a copolymer of vinyl chloride), and/or fluoro-containing vinyl monomers, such as vinyl fluoride, tetrafluoroethylene, perfluoroalkoxyvinyl monomers, and vinylidene fluoride (e.g., poly(vinylidenefluoride)), and polymers or copolymers of any of such monomers. The vinyl polymer can be a homopolymer, or alternatively, a copolymer derived from two or more different types of vinyl monomers (units). Some examples of different kinds of copolymers considered herein include alternating copolymers, block copolymers, graft copolymers, random copolymers, and combinations thereof. At least a portion of the vinyl polymer may be derived from one or more monomers containing an acrylate group. In one embodiment, the vinyl polymer is composed of both non-acrylate and acrylate units. In another embodiment, the vinyl polymer is composed completely of acrylate units, wherein the acrylate units may all be chemically the same (i.e., a homopolymer) or may be chemically different (i.e., a copolymer, a terpolymer or a higher polymer system).

In one embodiment, coating 29 may be in a solid form that is pre-shaped as a film, for example, and that is ready for application onto membrane 16. As used herein, the term “solid form” of the composition is used to mean a form of the composition that does not flow, cannot be impressed by a localized pressure, and that rigidly keeps its form under typical (standard) conditions. The composition can have the properties of a thermoplastic or a thermoset material. Alternatively, coating 29 can be in a non-solid form (e.g., a liquid or paste) before or during application of coating 29 onto membrane 16. However, coating 29, when not in solid form, has the property of being solidifiable by chemical alteration. As described herein, “chemical alteration” is a change in the chemical bonding structure of coating 29, as can be provided by such processes as radiation, thermal, or chemical curing. Accordingly, when coating 29 is in the non-solid state, it possesses appropriate chemical functionality to allow for solidification. The solidifying process can also include simply drying of coating 29 (or a solution thereof) onto membrane 16.

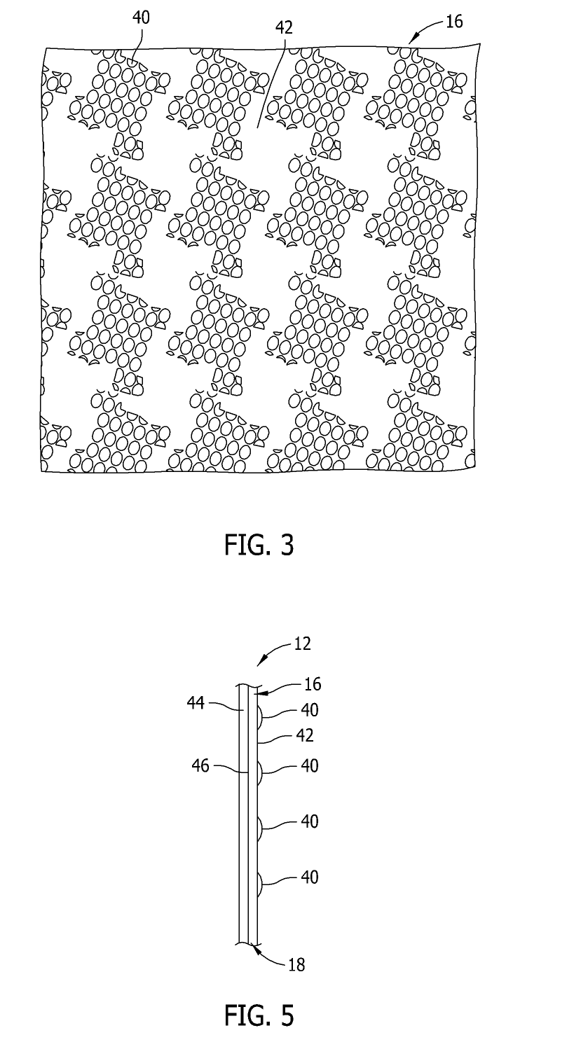

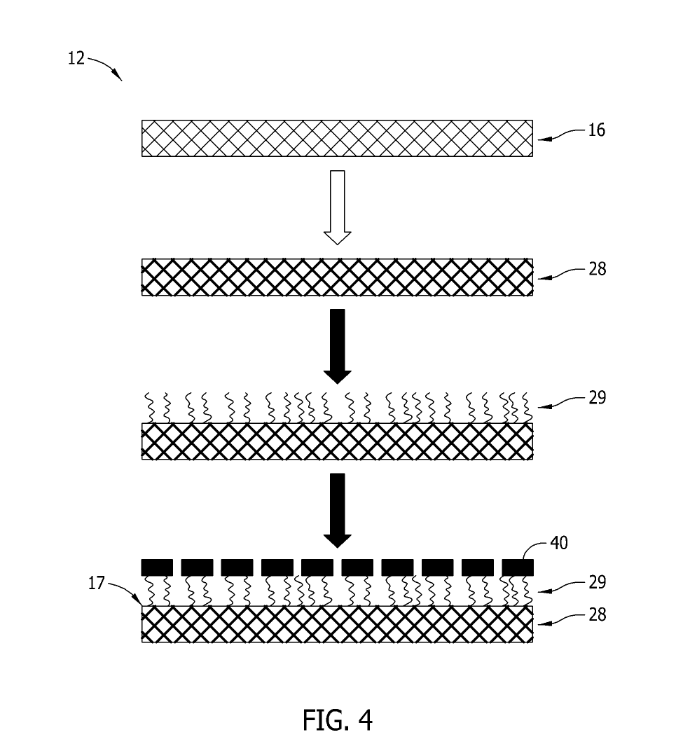

FIG. 3 is an enlarged view of a discontinuous patterned layer 40 formed from a plurality of particles and a polymeric binder applied to membrane structure 12 (shown in FIGS. 1 and 2). FIG. 4 is an exploded cross-sectional view of membrane structure 12 taken along area 4 (shown in FIG. 2) that illustrates discontinuous patterned layer 20 formed onto membrane structure 12. In the exemplary embodiment, particles used to form patterned layer 40 are selected to provide specific functionality to composite membrane structure 12 depending on its end use. For example, in some embodiments, the particles are chosen to provide abrasion resistance, surface chemical adsorption, aesthetic properties, and touch-and-feel characteristics. Suitable particles may include, but are not limited to, titanium oxide particles, zirconium dioxide particles, zinc oxide particles, carbon particles, activated carbon particles, and mixtures thereof. In the exemplary embodiment, the particles are dispersed in a polymeric binder that facilitates attachment of the particles to membrane 16. Suitable polymeric binders may include, but are not limited to, polyurethane polymers, cellulosic polymers, polyacrylate polymers, polyalcohol polymers, polyglycol polymers, and mixtures thereof. The polymeric binders are cured after being deposited onto membrane 16. The curing temperature will vary depending on the polymeric binder used. In one embodiment, the polymeric binders are cured at a temperature ranging from about 80° C. to about 180° C., in another embodiment, from 100° C. to about 150° C.

Referring also to FIG. 4, first coating layer 28 is applied onto membrane 16 such that membrane 16 is an oleophobic-treated membrane and then second coating 29 is applied onto oleophobic treated membrane. Patterned layer 40 is formed onto first side 17 of membrane 16. Alternatively, patterned layer 40 is formed onto first side 17 and/or second side 18 (shown in FIGS. 1 and 2) of membrane 16 that has second coating 29 applied thereon. More specifically, discontinuous patterned layer 40 is applied onto second coating 29. In the exemplary embodiment, patterned layer 40 is applied, such as but not limited to being printed, onto coating 29. Patterned layer 40 may be printed onto coating 29 by known printing processes, for example, but not limited to, transfer printing, roller printing, xerographic printing, flexographic printing, gravure-screen printing and combinations thereof. In the exemplary embodiment, any pattern (i.e., regular, irregular, and/or discontinuous) may be applied and/or printed onto at least thirty percent of the surface area of coating 29.

FIG. 5 is an enlarged end view of membrane structure 12 and illustrates that a fabric layer 44 may be laminated on membrane 16. For example, fabric layer 44 may be laminated on second side 18 of membrane 16. Alternatively, fabric layer 44 may laminated onto first side 17 (shown in FIGS. 1, 2, and 4) and/or second side 18 of membrane 16. The combination of fabric layer 44 and membrane 16 may be used to form articles, such as but not limited to garments, apparel, tent walls, sleeping bags, and packaging. The oleophobic and printed membrane 16 may be used to eliminate the need of a liner/backer layer for different apparel applications, for example, 2-layer unlined jackets, pants, and shirts. Fabric layer 44 may be formed from a woven, nonwoven, or knitted fabric constructed from fibers formed from at least one of polyamides, polyesters, polyolefins, thermoplastic polyurethanes, elastomers, polyetherimides, liquid crystal polymers, polyphenyl ethers, polyphenylene sulfides, cotton, and aramids.

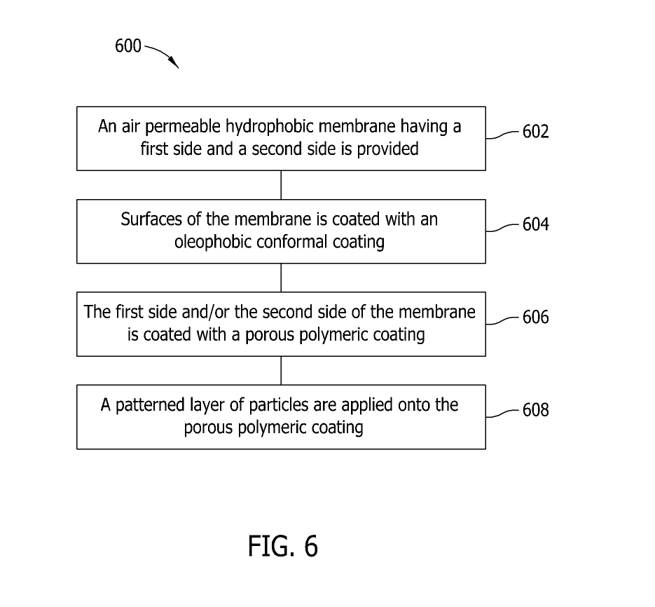

FIG. 6 is a flow chart of an exemplary method 600 of making a membrane structure, such as membrane structure 12 (shown in FIGS. 1, 2, 4, and 5). In the exemplary embodiment, an air permeable hydrophobic membrane 16 (shown in FIGS. 1, 2, 3, 4 and 5) having a first side 17 (shown in FIGS. 1, 2, and 4) and a second side 18 (shown in FIGS. 1, 2, and 5) is provided 602. Surfaces of membrane 16 is coated 604 with an oleophobic conformal coating 28 (shown in FIGS. 2 and 4) to impart oleophobic properties to membrane 16. First side 17 and/or second side 18 of membrane 16 is coated 606 with a porous polymeric coating 29 (shown in FIGS. 2 and 4). A patterned layer of particles are applied, such as being printed 608 onto porous polymeric coating 29 to form a patterned layer 40 (shown in FIGS. 3, 4, and 5).

The embodiments described herein provide a membrane structure that may be used with articles, such as but not limited to garments, apparel, tent walls, sleeping bags, and packaging, wherein the membrane structure is protected from oil contamination and, at the same time, is air permeable and waterproof. More specifically, the embodiments described herein include a membrane structure that includes an air permeable hydrophobic membrane having a first side and an opposite second side. An oleophobic conformal coating is applied across the membrane. A porous polymeric coating is applied onto the first side and/or the second side of the membrane. A patterned layer of particles are applied onto the porous polymeric coating. Accordingly, the membrane structure is treated to have various desired functionalities, such as being air permeable, waterproof, breathable, and oleophobic. Such treatment also enables the membrane structure to have enhanced mechanical stability, abrasion durability, surface chemicals adsorptivity, antistatic properties, antimicrobial properties, bio-compatibility, and fouling resistance.

Exemplary embodiments of the membrane structures and methods are described above in detail. The membrane structures and methods are not limited to the specific embodiments described herein, but rather, components of the structures and/or steps of the methods may be utilized independently and separately from other components and/or steps described herein. For example, the system may also be used in combination with other structures and methods, and is not limited to practice with only the structure as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A membrane structure comprising:
an air permeable hydrophobic membrane comprising a first side and an opposite second side;
an oleophobic conformal coating applied across said membrane;
a porous polymeric coating applied onto at least one of said first side and said second side of said membrane; and
a patterned layer of particles applied onto said porous polymeric coating.

2. A membrane structure in accordance with claim 1, wherein said oleophobic conformal coating comprises a fluoropolymer having oleophobic properties.

3. A membrane structure in accordance with claim 1, wherein said porous polymeric coating comprises a porous polyurethane.

4. A membrane structure in accordance with claim 1, wherein said patterned layer of particles is applied onto said porous polymeric coating via at least one of transfer printing, roller printing, xerographic printing, flexographic printing, and gravure-screen printing.

5. A membrane structure in accordance with claim 1, wherein said patterned layer of particles comprise at least one of titanium oxide particles, zirconium dioxide particles, zinc oxide particles, carbon particles, and activated carbon particles.

6. A membrane structure in accordance with claim 1, wherein said patterned layer of particles further comprise a polymeric binder comprising at least one of polyurethane polymers, cellulosic polymers, polyacrylate polymers, polyalcohol polymers, and polyglycol polymers.

7. A membrane structure in accordance with claim 1, wherein said membrane comprises at least one of polyolefin, polyamide, polyester, polysulfone, polyether, acrylic, methacrylic, polystyrene, polyurethane, polypropylene, polyethylene, expanded polytetrafluoroethylene (ePTFE), woven PTFE, and non-woven PTFE.

8. A membrane structure comprising:
an air permeable hydrophobic membrane fabricated from expanded polytetrafluoroethylene (ePTFE), said membrane comprising a first side and an opposite second side;
an oleophobic conformal coating applied across said membrane, said oleophobic conformal coating comprising an oleophobic fluoropolymer in the range of about 0.5 wt % to about 1.5 wt % and an amount of a solvent in the range of about 50 wt % to about 75 wt %;
a porous polymeric coating that is polar applied onto said first side of said membrane; and
a patterned layer of particles applied onto at least thirty percent of the surface area of said porous polymeric coating.

9. An article comprising a first layer and a second layer, said first layer comprising a fabric, said second layer comprising:
an air permeable hydrophobic membrane comprising a first side and an opposite second side;
an oleophobic conformal coating applied to across said membrane;
a porous polymeric coating applied onto at least one of said first side and said second side of said membrane; and
a patterned layer of particles applied onto said porous polymeric coating.

10. An article in accordance with claim 9, wherein said oleophobic conformal coating comprises a fluoropolymer having oleophobic properties.

11. An article in accordance with claim 9, wherein said porous polymeric coating comprises a porous polyurethane.

12. An article in accordance with claim 9, wherein said patterned layer of particles is applied onto said porous polymeric coating via at least one of transfer printing, roller printing, xerographic printing, flexographic printing, and gravure-screen printing.

13. An article in accordance with claim 9, wherein said patterned layer of particles comprise at least one of titanium oxide particles, zirconium dioxide particles, zinc oxide particles, carbon particles, and activated carbon particles.

14. An article in accordance with claim 9, wherein said patterned layer of particles further comprise a polymeric binder comprising at least one of polyurethane polymers, cellulosic polymers, polyacrylate polymers, polyalcohol polymers, and polyglycol polymers.

15. An article in accordance with claim 9, wherein said membrane comprises at least one of polyolefin, polyamide, polyester, polysulfone, polyether, acrylic, methacrylic, polystyrene, polyurethane, polypropylene, polyethylene, expanded polytetrafluoroethylene (ePTFE), woven PTFE, and non-woven PTFE.

16. A method of making a membrane structure comprising:
providing an air permeable hydrophobic membrane having a first side and an opposite second side;
coating the membrane with an oleophobic conformal coating to impart oleophobic properties to the membrane;
coating at least one of the first side and the second side of the membrane with a porous polymeric coating; and
applying a patterned layer of particles onto the porous polymeric coating.

17. A method in accordance with claim 16, wherein coating the surfaces of the membrane further comprises coating the surfaces of the membrane with a fluoropolymer having oleophobic properties.

18. A method in accordance with claim 16, wherein coating at least one of the first side and the second side further comprises coating at least one of the first side and the second side with a porous polyurethane.

19. A method in accordance with claim 16, wherein applying a patterned layer of particles further comprises printing a patterned layer of particles onto the porous polymeric coating by at least one of transfer printing, roller printing, xerographic printing, flexographic printing, and gravure-screen printing.

20. A method in accordance with claim 16, wherein providing an air permeable hydrophobic membrane further comprises providing an air permeable hydrophobic membrane that includes at least one of polyolefin, polyamide, polyester, polysulfone, polyether, acrylic, methacrylic, polystyrene, polyurethane, polypropylene, polyethylene, expanded polytetrafluoroethylene (ePTFE), woven PTFE, and non-woven PTFE.
